(19) United States
(12) Patent Application Publication
(10) Pub. No.: US 2007/0300051 A1
(43) Pub. Date: Dec. 27, 2007

(54) Out of band asset management

(76) Inventors: Michael A. Rothman, Puyallup, WA (US); Vincent J. Zimmer, Federal Way, WA (US)

Correspondence Address: INTEL CORPORATION;c/o INTELLEVATE, LLC, P.O. BOX 52050, MINNEAPOLIS, MN, 55402, US

(21) Appl. No.: 11/474,722

(22) Filed: Jun. 26, 2006

(51) Int. Cl. G06F 9/44

(52) U.S. Cl. 713/1; 717/168

(57) ABSTRACT

The present disclosure relates to managing assets utilizing an out-of-band microcontroller and, more specifically, to communicating with an administration agent utilizing an out-of-band microcontroller and a shared memory space.

### BACKGROUND

1. Field

The present disclosure relates to managing assets utilizing an out-of-band microcontroller and, more specifically, to communicating with an administration agent utilizing an out-of-band microcontroller and a shared memory space.

2. Background Information

Typical asset management solutions depend upon an in-band platform agent for responding to external requests for information about a given platform target. Often this involves installing an operating system specific piece of software on a target computing system. Occasionally, the platform agent software may be part of the platforms operating system.

Typically, in order for the in-band platform agent to be able to respond at least three things must occur: (1) the platform must be turned on and operating, (2) the operating system specific platform agent must be installed, and (3) the platform, including its operating system, must be sufficiently functional to run the platform agent and respond to the request. If any of these three minimum requirements are not met the platform agent will likely miss the external request. As a result, an Information Technology department will be required to send multiple requests across the network for an extended amount of time in order to reach all targeted computing systems.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a f block diagram illustrating an embodiment of an apparatus and system in accordance with the disclosed subject matter;

FIG. 2 is a flow chart illustrating an embodiment of a management scheme in accordance with the disclosed subject matter; and

FIG. 3 is a flow chart illustrating an embodiment of a management scheme in accordance with the disclosed subject matter.

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

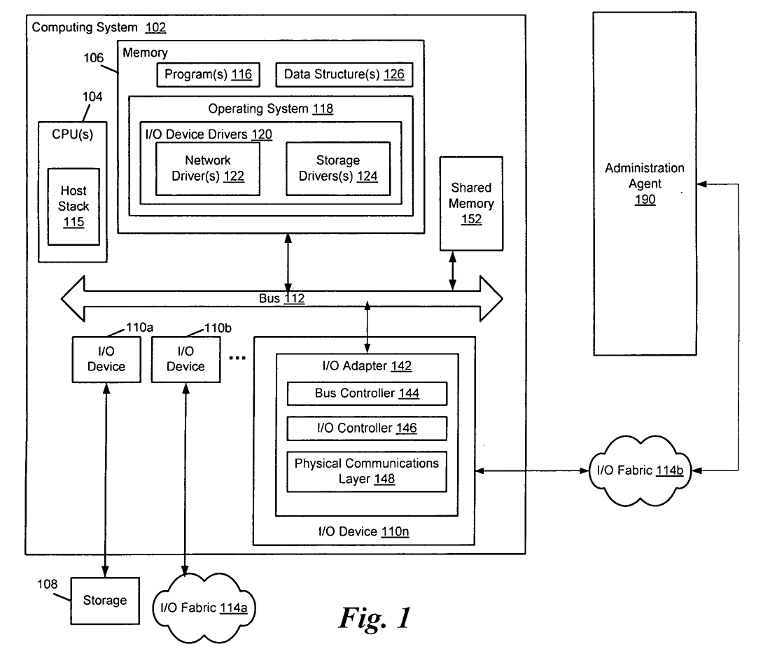

FIG. 1 is a block diagram illustrating a computing environment in which aspects of described embodiments may be employed. It is understood that in some embodiments the computing environment or portions thereof may be physical, virtual, or a combination thereof. A host computing system 102 may include one or more system processors or central processing units (CPUs) 104, a volatile memory 106 and an I/O device 108 which is, in an embodiment, a non-volatile storage 108 (e.g., magnetic disk drives, optical disk drives, a tape drive, etc.). The host computing system may be coupled to one or more I/O devices 110a, 110b, . . . 110n via one or more buses such as a local bus 112, which is maintained on a board supported on a local chassis 111. In the illustrated embodiment, the I/O device 110a is a storage controller, the I/O device 110b is a network controller and the I/O device 110n is depicted as an out-of band microcontroller (herein referred to as “OOB μcontroller”). Any number of I/O devices 110a, 110b, . . . 110n including video controllers, port adapters etc. may be attached to the local bus 112 of the host computing system 102.

The host computing system 102 may use I/O devices in performing I/O operations (e.g., network I/O operations, storage I/O operations, etc.). Thus, the I/O device 110a may be used as a storage controller for storage such as the storage 108, for example, which may be directly connected to the host computer 102 or may be connected by a network.

An I/O device such as a storage controller may control the reading of data from and the writing of data to the storage 108 in accordance with a storage protocol layer. The storage protocol may be any of a number of suitable storage protocols including Redundant Array of Independent Disks (RAID), High Speed Serialized Advanced Technology Attachment (SATA), parallel Small Computer System Interface (SCSI), serial attached SCSI, etc. Data being written to or read from the storage 108 may be cached in a cache in accordance with suitable caching techniques. The storage controller may be integrated into the CPU chipset, which can include various controllers including a system controller, peripheral controller, memory controller, hub controller, I/O bus controller, etc.

A host stack 115 may execute on at least one CPU 104. A host stack may be described as software that includes programs, libraries, drivers, and an operating system that run on host processors (e.g., CPU 104) of a host computing system 102. One or more programs 116 (e.g., host software, application programs, and/or other programs) and an operating system 118 may reside in memory 106 during execution and execute on one or more CPUs 104.

The host computing system 102 may comprise any suitable computing device, such as a mainframe, server, personal computer, workstation, laptop, handheld computer, telephony device, network appliance, virtualization device, storage controller, etc. Any suitable CPU 104 and operating system 118 may be used. Programs and data in memory 106 may be swapped between memory 106 and storage 108 as part of memory management operations.

Operating system 118 includes I/O device drivers 120. The I/O device drivers 120 include one or more network drivers 122 and one or more storage drivers 124 that reside in memory 106 during execution. The network drivers 122 and storage drivers 124 may be described as types of I/O device drivers 120. The I/O drivers 120 may also include drivers for one or more remote I/O devices (not shown). Also, one or more data structures 126 are in memory 106.

Each I/O device driver 120 may include I/O device specific commands to communicate with an associated I/O device 110a . . . 110n, and interfaces between the operating system 118, programs 116 and the associated I/O device 110a, 110b, . . . 110n. The I/O devices 110a, 110b, . . . 110n, and I/O device drivers 120 employ logic to process I/O functions.

Each I/O device 110a, 110b, . . . 110n includes various components implemented in the hardware of the I/O device 110a, 110b, . . . 110n. The I/O devices 110b, . . . 110n of the illustrated embodiment may each be capable of transmitting and receiving data over an I/O fabric 114a, 114b. The I/O fabrics 114a, 114b may be the same or different, or separate or combined. Each I/O fabric 114a, 114b may comprise a Local Area Network (LAN), the Internet, a Wide Area Network (WAN), a Storage Area Network (SAN), WiFi (Institute of Electrical and Electronics Engineers (IEEE) 802.11b, published Sep. 16, 1999), Wireless LAN (IEEE 802.11b, published Sep. 16, 1999), etc. I/O fabric 114b is typically an out-of-band connection used solely by the out-of-band μcontroller 110n. I/O fabric 114a is typically accessible via a network interface card operatively coupled to the processor 104 arrangements

Each I/O device 110a, 110b . . . 110n may include an I/O adapter 142, which in certain embodiments, is a Host Bus Adapter (HBA). In the illustrated embodiment, an I/O adapter 142 includes a bus controller 144, an I/O controller 146, and a physical communications layer 148. The bus controller 144 enables the I/O device 110a, 110b . . . 110n to communicate on a bus 112 which may comprise any suitable bus interface, such as any type of Peripheral Component Interconnect (PCI) bus (e.g., a PCI bus (PCI Special Interest Group, PCI Local Bus Specification, Rev 2.3, published Mar. 15, 2002), a PCI-X bus (PCI Special Interest Group, PCI-X 2.0a Protocol Specification, published 2002), or a PCI Express bus (PCI Special Interest Group, PCI Express Base Specification 1.0a, published 2002), published March 2002), Small Computer System Interface (SCSI) (American National Standards Institute (ANSI) SCSI Controller Commands-2 (SCC-2) NCITS.318:1998), Serial ATA ((SATA 1.0a Specification, published Feb. 4, 2003), etc or another type of peripheral bus.

The I/O controller 146 provides functions used to perform I/O functions. The physical communication layer 148 provides functionality to send and receive information over a network, or directly to and from an I/O device such as a storage device, a display, a printer, a keyboard, mouse etc. In the illustrated embodiment, the physical communication layer 148 of the network controller 110b and the OOB μcontroller 110n send and receive network packets to and from remote devices or computer systems over an I/O fabric 114a, 114b. When booting from a network target I/O device 110b will typically communicate with the target to receive boot instructions. In certain embodiments, the I/O controller 146 may implement the Ethernet protocol (IEEE std. 802.3, published Mar. 8, 2002) over unshielded twisted pair cable, TCP/IP (Transmission Control Protocol/Internet Protocol), Remote Direct Memory Access (RDMA), token ring protocol, Fibre Channel (IETF RFC 3643, published December 2003), Infiniband, or any other suitable networking protocol. Details on the TCP protocol are described in “Internet Engineering Task Force (IETF) Request for Comments (RFC) 793,” published September 1981, details on the IP protocol are described in “Internet Engineering Task Force (IETF) Request for Comments (RFC) 791, published September 1981, and details on the RDMA protocol are described in the technology specification “Architectural Specifications for RDMA over TCP/IP” Version 1.0 (October 2003).

The I/O device 110n may be integrated into the CPU chipset, which can include various controllers including a system controller, peripheral controller, memory controller, hub controller, I/O bus controller, etc. Alternatively, the OOB μcontroller 110n may comprise separate integrated circuits disposed on an expansion board which is connected to the local bus 112 in an expansion slot.

The I/O devices 110a, 110b . . . 110n may include additional hardware logic to perform additional operations. For example, the I/O controller 146 of the devices 110b, 110n of the illustrated embodiment may each include a network protocol layer to send and receive network packets to and from remote devices over the I/O fabric 114a, 114b. The I/O device 110b, 110n can control other protocol layers including a data link layer and the physical layer 148 which includes hardware such as a data transceiver.

Operations of the OOB μcontroller 110n and the CPU 104 may, in one embodiment, facilitate communication between the OOB μcontroller 110n and the CPU 104 independent of the state of the CPU 104. In an embodiment, messages containing directives to the host computer 102 may be posted by the OOB μcontroller 110n for a number of activities such as firmware updates, operating system updates, driver updates, retrieval of information such as software version data, etc. Directives may be forwarded from external sources, such as, for example, Administration Agent 190, or servers, peer-to-peer communications, administrator workstations, etc. Information retrieved in response to directives may be obtained from a variety of sources including firmware, operating systems, drivers, applications, etc., and forwarded to external targets or sources.

In an embodiment, implementation of “mailboxes” to pass messages and data between the in-band and out-of-band processor is according to techniques discussed in U.S. patent application Ser. No. 10/964,355 (Attorney Docket: P19896), entitled “BUS COMMUNICATION EMULATION” to Rothman et al. and filed on Oct. 12, 2004.

The OOB μcontroller 110n may be operated to store a “message” containing a directive in a memory shared by the OOB μcontroller 110n, a processor of the computer system such as the CPU 104 of the host computer 102. In the illustrated embodiment, the host computer 102 includes a shared memory 152 which is accessible by both the CPU 104 and the OOB μcontroller 110n. The shared memory 152 may reside in a reserved area of RAM, or be located in a separate non-volatile memory store, or the like. The shared memory may be operated as a mailbox for these messages. Thus, in one aspect, the OOB μcontroller 110n may store a message in the shared memory 152 or retrieve a message from the shared memory 152, independently of the status of the host computer 102 including the status of the CPU 104, the operating system 118 and the programs 116. Thus, in the illustrated embodiment, the OOB μcontroller 110n may store or retrieve messages in the shared memory 152 whether the CPU 104 is being initialized or is turned off, or whether the operating system 118 is booting, running, crashed or otherwise.

To facilitate such independent operation, in this example, the controller 110n, the shared memory 152, the local bus 112 and other components as appropriate may be powered independently of the main components of the host computer 102 including the CPU 104 and the host memory 106. The shared memory 152 may be non-volatile (NV) memory such as flash memory or static random access memory (SRAM). In embodiments described in more detail below, the OOB μcontroller 110n may operate independently of the operating system 118 or system start-up program, such that the OOB μcontroller 110n may have its own dedicated control circuitry, firmware, operating system, etc. to control the operations of the OOB μcontroller 110n independently of the status of the remainder of the host computer 102. It is appreciated that the degree of operational independence, if any, of the controller 110n and other components may vary, depending upon the particular application.

In the illustrated embodiment, the shared memory 152 may be a persistent, reserved portion of the storage 108 or a separate non-volatile memory. Accordingly, the memory safety of the operating system 118 can be maintained. For example, the OOB μcontroller 110n may avoid direct memory access operations into the main host memory 106.

A message intended for the CPU 104 may be marked to be read and processed by the CPU 104. The marking may occur before, during or after the message is actually stored in the shared memory 152.

The CPU 104, when operational, may read the message stored in the shared memory 152 and marked as intended for the CPU 104, and process any directive contained within the message. As previously mentioned, the directive may direct the CPU 104 to undertake any of a number of activities including updating firmware, drivers, operating system, or applications, applying patches, applying interrupts, retrieving information, etc.

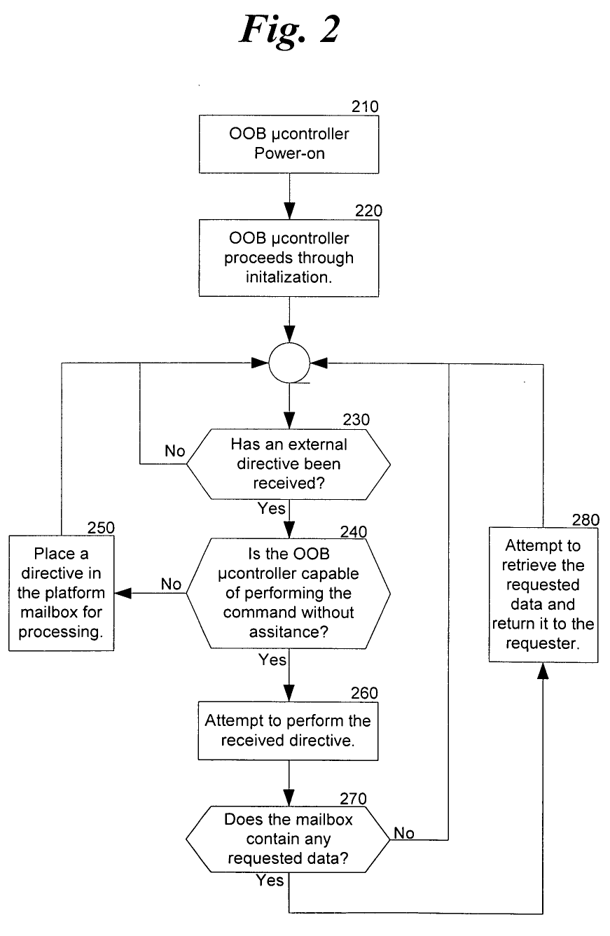

Conversely, a system processor such as the CPU 104 of the host computing system 102 may store a message in the shared memory 152. The storing of a message by the system processor may be in response to a directive contained in a message from the OOB μcontroller 110n, which was read from the shared memory 152 and processed by the CPU 104. The directive from the controller may have included instructions to retrieve certain information such as, for example, data describing the version of an application 116 of the host computer 102. This information may be packaged into a message which is stored by the CPU 104 into the shared memory 152. In one embodiment, the CPU 104 may interact with the memory 152 as illustrated in FIG. 2, and described in detail below.

A message intended for the controller 110n may be marked to be read and processed by the controller 110n. The marking may occur before, during or after the message is actually stored in the shared memory 152. A message so marked may be read by the controller 110n from the shared memory 152 and any directive or information contained within the message may be processed. For example, information contained within the message may be forwarded to an external source such as an administrator workstation, a second computer system, a server, or other external source, such as for example the administration agent 190.

In one embodiment, an external source, such as, for example the administration agent 190, may request information or actions be preformed by either or one of the host CPU 104 or the OOB μcontroller 110n. In order to fulfill these requests information or directives may be passed between the administration agent 190 and the CPU 104 via the OOB μcontroller 110n utilizing the shared memory 152. In one embodiment, the messages may be initiated by the CPU 104 or the OOB μcontroller 110n, as opposed to being initiated by the administration agent 190.

FIG. 2 is a flow chart illustrating an embodiment of a management scheme in accordance with the disclosed subject matter. Block 210 illustrates that, in one embodiment, the OOB μcontroller may power on. In one embodiment, the OOB μcontroller and other components as appropriate may be powered independently of the main components of the host computer including the CPU.

Block 220 illustrates that, in one embodiment, OOB μcontroller and any other components may proceed through initialization. Of course, in other embodiments, the OOB μcontroller may have already been established and operating. FIG. 2 shows a junction point which adds in the illustration and understanding of the technique illustrated by FIG. 2.

Block 230 illustrates that, in one embodiment, a determination may be made as to whether or not an external directive has been received. In one embodiment, the external directive may be received from an administration agent or another third party entity. In one embodiment, the directive may be received while the OOB μcontroller is effectively powered down, or otherwise unavailable.

In one specific illustrative embodiment, a system administrator may from, in this embodiment, a central location send out a request to all computing systems within a network. In one embodiment the request may facilitate the determination of what types and versions of software are installed on the machines on the network. Each computing system, via the computing system's OOB μcontroller, may receive a directive to list all types and versions of software on the OOB μcontroller's computing system. It is understood that other requests and directives may be issued to the OOB μcontroller including, but not limited to, updating software or firmware, altering policy management instructions or rules, collecting usage data, request for various data, licensing validation or termination, information regarding hardware configurations and status, virus scanning and cleaning, etc. Of course other forms of asset management are contemplated and within the scope of the disclosed subject matter.

If no directives have been received, in one embodiment, the OOB μcontroller may loop until a directive is received. In another embodiment, the OOB may perform other tasks and periodically, or otherwise, check to see if a directive has been received. In another embodiment, the OOB μcontroller may skip to Block 270 (discussed below). Likewise, in another embodiment, the OOB μcontroller may periodically, or otherwise, perform the action illustrated by Block 270.

Block 240 illustrates that, in one embodiment, if a directive has been received, a determination may be made as to whether or not the OOB μcontroller is capable of performing the command without assistance. In one embodiment, the command, directive, or request may be capable of being performed by the OOB μcontroller without the rest of the computing system being operational. In another embodiment, the directive may only be capable of being performed by the OOB μcontroller when the rest of the computing system is operational, such as, for example, powered on. In yet another embodiment, the directive may be capable of being partially, but not fully, completed by the OOB μcontroller without assistance. In one embodiment, the assistance may be required from the rest of the computing system. In another embodiment, the assistance may be required from a third entity or external device or system. Alternatively, in one embodiment, assistance may be required from both the host computing system and an external entity. In yet another embodiment, the directive may be capable of being completed by the OOB μcontroller, but the OOB μcontroller or other entity may select not to have the OOB μcontroller complete the directive.

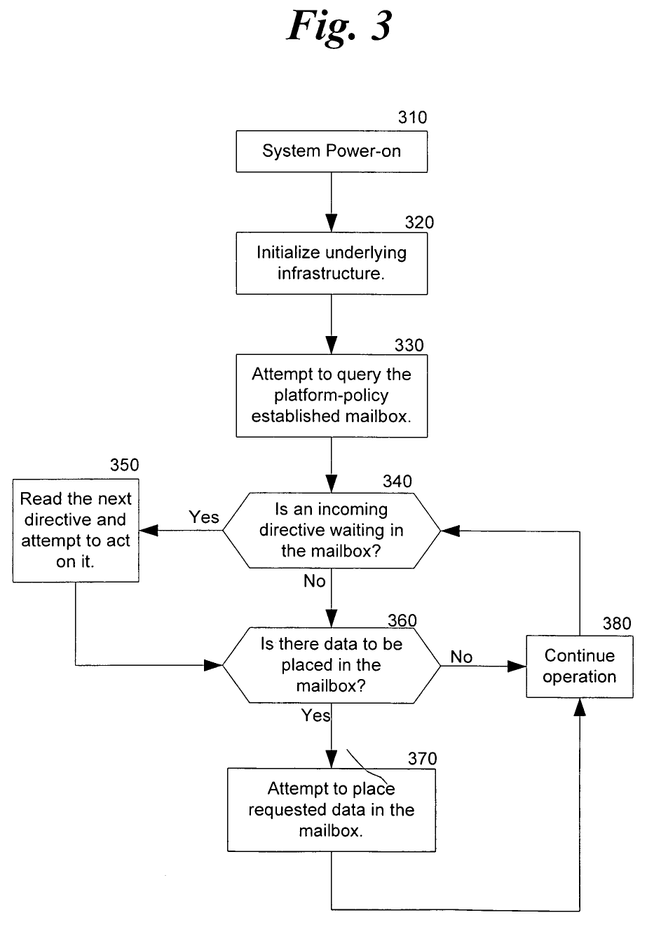

Block 250 illustrates that, in one embodiment, if the directive is not being performed by the OOB μcontroller, the OOB μcontroller may place a directive, or in another embodiment a derivative or related directive, in the platform or computing system mailbox for processing. In one embodiment, this deferred directive may be dealt with by the computing system, or the host CPU. In one embodiment the deferred or displaced directive may be dealt with utilizing the technique illustrated in FIG. 3 and described below.

Block 260 illustrates that, in one embodiment, if the OOB μcontroller is capable of performing the received directive, the OOB μcontroller may attempt to perform the received directive. In other embodiments, if the received directive needs to be performed by an external entity, the deferred directive may be placed or transferred to the external entity. In one embodiment, the OOB μcontroller may apply power to other components of the computing system in order to facilitate the performance of the directive. In one specific illustrative example, the OB μcontroller may apply power to a hard drive, or the storage device if the received directive requires information to be retrieved from the storage device. In one embodiment, a policy may exist to limit the OOB μcontroller's ability to alter the power usage of the computing system or otherwise access components of the computing system.

Block 270 illustrates that, in one embodiment, a determination may be made as to whether or not the mailbox contains any requested data. In one embodiment, directives may also be received via the memory mailbox. In one embodiment, the returned data may be response to a deferred directive request that was forwarded to the host computing system during the action illustrated in Block 250. In one embodiment, this returned data may be a result of a deferred directive that was part of another instance of the technique illustrated by FIG. 2. The returned data may even be a result of a deferred directive from a pervious power cycling of the computing system.

Block 280 illustrates that, in one embodiment, if requested or returned data has been placed in the mailbox, the OOB μcontroller may attempt to retrieve the data and return it to the ultimate requesting entity. In one embodiment, the OOB μcontroller may attempt to return the data to external entity which initiated the external directive. In another embodiment, the OOB μcontroller may be directed, either via the external directive or another technique, to return the data to another external entity. In one embodiment, the OOB μcontroller may communicate with the external entity via an out-of-band network or protocol. In one embodiment, the out-of-band network may utilize the same physical medium, such as, for example, the same network cable or antenna, as the primary or normal networking component of the host computing system.

In one specific illustrative embodiment, discussed in regards to Block 230, the system administrator may be waiting for data to be returned regarding the administrator's query regarding the types and versions of software installed on the various machines in the network. The OOB μcontroller may receive this directive (block 230). All, portions, or none of the information may be capable of being performed by the OOB μcontroller alone. For example, the OOB μcontroller may be capable for reporting the BIOS type and version, but no the operating system type and version, as one illustrative non-limiting example embodiment. The OOB μcontroller may forward a modified directive (for the OS type and version) to the host computing system (block 250). The OOB μcontroller may return the requested data regarding the BIOS to the system administrator (block 260). The OOB μcontroller may wait for the host computing system to perform the requested action and deposit the information in the mailbox (block 270). Once the requested information has been retrieved the OOB μcontroller may forward the information to the system administrator (block 280). In one embodiment, the OOB μcontroller may wait to forward data back to the system administrator until all requested data has been collected, as opposed to returning the data in a piecemeal fashion. Of course, this is merely a few specific illustrative embodiments of the disclosed subject matter and other embodiments are contemplated and within the scope of the disclosed subject matter.

FIG. 3 is a flow chart illustrating an embodiment of a management scheme in accordance with the disclosed subject matter. Block 310 illustrates that, in one embodiment, the computing system may power on. In one embodiment, the computing system and other components as appropriate may be powered independently of the OOB μcontroller components of the host computer.

Block 320 illustrates that, in one embodiment, computing system may proceed through initialization. Of course, in other embodiments, the computing system, or a portion of it, specifically the OOB μcontroller and related components, may have already been established and operating.

Block 330 illustrates that, in one embodiment, the computing system may attempt to query the mailbox. In one embodiment the mailbox may be established via a platform policy. In one embodiment, the mailbox may reside in a portion of system memory. In another embodiment, the mailbox may reside in a reserved memory or storage space. In yet another embodiment, the mailbox may reside in a plurality of locations or memory spaces. In one embodiment, the mailbox may include incoming and outgoing portions. Wherein the incoming portion may hold messages coming into the main computing system, and the outgoing portion may hold messages going out to the OOB μcontroller. In one embodiment, querying the mailbox may involve interacting with the OOB μcontroller, whereas, in another embodiment, the mailbox may be accessed without involving the OOB μcontroller.

Block 340 illustrates that, in one embodiment, a determination may be made as to whether or not an incoming directive is waiting in the mailbox. In one embodiment, the directive may have been placed in the mailbox utilizing a technique illustrated by FIG. 2 and described above. While the illustrated embodiment shows directives being collected individually, in another embodiment, directives and data may be processed in groups (i.e. batch mode).

Block 350 illustrates that, in one embodiment, if an incoming directive is in the mailbox, the computing system may attempt to read the next directive and act upon it. In one embodiment, the directives may be taken out-of-order. In one embodiment, the directives may be handled in a serial fashion, a parallel fashion, or a combination thereof. It is contemplated that a variety of actions may be preformed or requested of the computing platform, many of which are described above; however other actions are within the scope of the disclosed subject matter. In one embodiment, the computing platform may not be able to perform the requested action, in which case, it is completed that an error handling system (not illustrated) may be used.

Block 360 illustrates that, in one embodiment, once an action has been performed, or if no action needs to be performed, a determination may be made as to whether or not there is data to be placed in the mailbox. In one embodiment, the data may be a directive to the OOB μcontroller or another entity. In another embodiment, the data may be an indication of success or failure. In yet another embodiment, the lack of data in the mailbox may be construed as a form of data or information, such as, for example, the lack of data being indicative of an action not being completed or that the requested action was performed successfully. In a further embodiment, the computing platform may be instructed to place data in a location other than the mailbox.

Block 370 illustrates that, in one embodiment, an attempt may be made to place the requested data in the mailbox. In one embodiment, the data may be placed in the mailbox by writing the data to a memory location. In another embodiment, the data may be written to a file. In one embodiment, the requested data may be read and utilized as illustrated by FIG. 2 and described above.

Block 380 illustrates that, in one embodiment, the computing system may continue to operate normally. In one embodiment, the processing of directives may take priority over normal computing system operations. In another embodiment, the directives may have a lower priority. In a further embodiment, the priority level for the directives may be based upon a flag set in or associated with the directives or merely based upon an association with the directives themselves or the entity that initiated or handled the directives. In one embodiment, the processing of directives may occur in parallel with other normal operations associated with the computing system. In other embodiments, the processing of directives may block some or all of the normal operations of the computing system.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

1. A method for managing computing assets comprising:
sending a directive (i.e. a sent directive) from an administration agent to at least one computing system that includes an out-of-band (OOB) micro-controller (μcontroller), a host computing system, and a shared memory that is shared between the OOB μcontroller and the host computing system; and
wherein sending the directive is the cause of actions including:
the OOB μcontroller receiving the sent directive;
the OOB μcontroller attempting to perform the sent directive;
the OOB μcontroller placing a directive (i.e. a displaced directive) in the shared memory if action is needed by the host computing system to perform the sent directive;
the OOB μcontroller sending data to the administrative agent in response to the sent directive.

2. The method of claim 1, wherein sending the directive is the cause of actions including:
the OOB μcontroller determining if the OOB μcontroller is able to perform the sent directive without assistance; and
if not, placing the displaced directive in the shared memory to be processed by the host computing system;
wherein the displaced directive is associated with the sent directive.

3. The method of claim 2, wherein sending the directive is the cause of actions including:
the host computing system checking if there is a displaced directive in the shared memory;
if so, the host computing system attempting to perform the displaced directive; and; and
the host computing system placing data associated with the performance of the displaced directive in the shared memory.

4. The method of claim 2, wherein sending the directive is the cause of actions including:
the OOB μcontroller checking the shared memory to determine if results of the displaced directive (i.e. the requested data) has been placed in the shared memory; and
if so, the OOB μcontroller utilizing, at least in part, the requested data to complete the sent directive.

5. The method of claim 1, wherein the sent directive includes a directive selected from a group consisting essentially of:
updating software;
updating firmware;
altering policy management rules;
collecting usage data;
confirming licensing validation;
requesting licensing termination;
requesting information regarding hardware configuration;
requesting information regarding hardware status; and
virus scanning and cleaning.

6. The method of claim 1, wherein the OOB μcontroller receiving the sent directive includes:
receiving the sent directive from the administration agent when the host computing system is substantially powered down.

7. An article comprising:
a tangible medium having a plurality of machine accessible instructions, wherein when the instructions are executed, the instructions provide for:
sending a directive (i.e. a sent directive) from an administration agent to at least one computing system that includes an out-of-band (OOB) micro-controller (μcontroller), a host computing system, and a shared memory that is shared between the OOB μcontroller and the host computing system; and
wherein sending the directive is the cause of actions including:
the OOB μcontroller receiving the sent directive;
the OOB μcontroller attempting to perform the sent directive;
the OOB μcontroller placing a directive (i.e. a displaced directive) in the shared memory if action is needed by the host computing system to perform the sent directive;
the OOB μcontroller sending data to the administrative agent in response to the sent directive.

8. A system comprising:
an external entity capable of initiating a sent directive to at least a targeted platform; and
the targeted platform including:
an out-of-band (OOB) microcontroller (μcontroller) capable of receiving the sent directive,
a host computing system, and
a shared memory capable of being shared between the OOB μcontroller and the host computing system; and
wherein the OOB μcontroller is further capable of
attempting to perform the sent directive,
placing a directive (i.e. a displaced directive) in the shared memory if action is needed by the host computing system to perform the sent directive, and
sending data to the administrative agent in response to the sent directive.

9. The system of claim 8, wherein the OOB μcontroller is capable of:
determining if the OOB μcontroller is able to perform the sent directive without assistance; and
if not, placing the displaced directive in the shared memory to be processed by the host computing system;
wherein the displaced directive is associated with the sent directive.

10. The system of claim 9, wherein the host computing system is capable of:
checking if there is a displaced directive in the shared memory;
if so, attempting to perform the displaced directive; and; and
placing data associated with the performance of the displaced directive in the shared memory.

11. The system of claim 9, wherein the OOB μcontroller is capable of:
checking the shared memory to determine if the results of the displaced directive (i.e. the requested data) has been placed in the shared memory; and
if so, utilizing, at least in part, the requested data to complete the sent directive.

12. The system of claim 8, wherein the sent directive includes a directive selected from a group consisting essentially of:
updating software;
updating firmware;
altering policy management rules;
collecting usage data;
confirming licensing validation;
requesting licensing termination;
requesting information regarding hardware configuration;
requesting information regarding hardware status; and
virus scanning and cleaning.

13. The system of claim 8, wherein the OOB μcontroller receiving the sent directive includes:
receiving the sent directive from the external entity when the host computing system is substantially powered down.

14. A method of utilizing an out-of-band (OOB) microcontroller (μcontroller) of a host computing system comprising:
receiving a directive from an external entity;
attempting to perform the received directive utilizing in part a memory shared by the OOB μcontroller and the host computing system.

15. The method of claim 14, wherein attempting to perform the received directive includes:
determining if the OOB μcontroller is able to perform the received directive without assistance; and
if so, attempting to perform the received directive, and
attempting to return the results of the received directive to the external entity via an out-of-band (OOB) channel.

16. The method of claim 14, wherein attempting to perform the received directive includes:
determining if the OOB μcontroller is able to perform the received directive without assistance; and
if not, placing a displaced directive in the shared memory to be processed by the host computing system;
wherein the displaced directive is associated with the received directive.

17. The method of claim 16, wherein attempting to perform the received directive further includes:
checking the shared memory to see if data requested by the displaced directive (the requested data) has been placed in the shared memory; and
if so, utilizing, at least in part, that requested data to complete the received directive.

18. The method of claim 17, wherein utilizing, at least in part, that requested data to complete the received directive includes:
attempting to transmit the requested data to the external entity utilizing an OOB channel.

19. The method of claim 14, wherein receiving a directive from an external entity includes:
receiving the directive from the external entity when the host computing system is substantially powered down.

20. The method of claim 14, further including:
checking the shared memory to determine if data requested by the OOB μcontroller from the host computer system (the requested data) has been placed in the shared memory; and
if so, utilizing, at least in part, that requested data to complete at least one received directive;
wherein the at leas tone received directive is either a currently received directive or a previously received directive.

21. A method comprising:
querying a shared memory that is shared between a host computing system and an out-of-band (OOB) microcontroller (μcontroller);
determining if a displaced directive has been placed in the shared memory by the OOB μcontroller;
if so, attempting to perform the displaced directive;
wherein the displaced directive is associated with a directive received by the OOB μcontroller from an external entity.

22. The method of claim 20, wherein attempting to perform the displaced directive includes:
producing at least one piece of data that was requested by the displaced directive (i.e. the requested data);
placing the requested data in the shared memory.

23. The method of claim 20, wherein the displaced directive includes a directive selected from a group consisting essentially of:
updating software;
updating firmware;
altering policy management rules;
collecting usage data;
confirming licensing validation;
requesting licensing termination;
requesting information regarding hardware configuration;
requesting information regarding hardware status; and
virus scanning and cleaning.

24. The method of claim 20, wherein the displaced directive is substantially equivalent to the directive received by the OOB μcontroller from the external entity.

25. An article comprising:
a tangible medium having a plurality of machine accessible instructions, wherein when the instructions are executed, the instructions provide for:
utilizing an out-of-band (OOB) microcontroller (μcontroller) of a host computing system to
receive a directive from an external entity; and
attempt to perform the received directive utilizing in part a memory shared by the OOB μcontroller and the host computing system.
